(19) United States
(12) Patent Application Publication
(10) Pub. No.: US 2018/0191011 A1
(43) Pub. Date: Jul. 5, 2018

(54) FUEL CELL EMERGENCY POWER SYSTEM

(71) Applicant: GE Aviation Systems Limited, Cheltenham, Gloucestershire (GB)

(72) Inventor: Colin John HALSEY, Tewkesbury (GB)

(21) Appl. No.: 15/741,231

(22) PCT Filed: Jun. 28, 2016
(86) PCT No.: PCT/EP2016/065025

§ 371 Date: Dec. 29, 2017

Related U.S. Application Data
(60) Provisional application No. 62/185,894, filed on Jun. 29, 2015.

(51) Int. Cl. H01M 8/065; H01M 8/04014; H01M 8/04746; H01M 8/04537; B64D 41/00

(52) U.S. Cl. CPC H01M 8/065; H01M 8/04014; H01M 8/04753; B64D 2041/005; B64D 41/00; H01M 2250/20; H01M 2250/405; H01M 8/04626

(57) ABSTRACT

A method and system (60) for generating emergency power includes a hydrogen storage system (62) configured to supply hydrogen gas, an air delivery system (64) configured to supply air at a predetermined temperature, and a fuel cell system (66) coupled with the hydrogen storage system and the air delivery system and configured to generate power at a power output from a chemical reaction involving the hydrogen gas and the air at the predetermined temperature.

### CROSS-REFERENCE TO RELATED APPLICATIONS

The present application claims the benefit of U.S. Provisional Patent Application No. 62/185,894, filed Jun. 29, 2015, which is incorporated by reference herein in its entirety.

### BACKGROUND

Hydrogen can be a fuel for creating consumable energy by way of combustion in an engine or by way of conversion from chemical energy into electrical energy through a chemical reaction, such as in a fuel cell. In the aforementioned examples, the hydrogen fuel is typically supplied in gaseous form. In order to generate consumable energy for an extended period of time in such systems, a large amount of hydrogen gas, and thus a large amount of potential energy, can be stored for consumption.

Fuel cell systems can be utilized to provide or supplement electrical energy systems for a vehicle, such as an aircraft. In addition to powering systems during various flight stages (e.g. take-off, cruise, landing), fuel cell systems can be configured to provide temporary electrical energy for a set of electrical systems during short periods of time, or under emergency conditions.

### BRIEF DESCRIPTION

In one aspect, an emergency power system includes a hydrogen storage system configured to supply hydrogen gas, a ram air intake, an air delivery system configured to supply air from the ram air intake at a predetermined temperature, and a fuel cell system coupled with the hydrogen storage system and the air delivery system and configured to generate power at a power output from a chemical reaction involving the hydrogen gas and the air at the predetermined temperature.

In another aspect, an aircraft includes a hydrogen storage system configured to supply hydrogen gas, an air delivery system having a ram air intake exposed to an airstream external to the aircraft and configured to supply air at a predetermined temperature, and a fuel cell emergency power system coupled with the hydrogen storage system and the air delivery system and configured to generate power at a power output from a chemical reaction involving the hydrogen gas and the air at the predetermined temperature.

In yet another aspect, a method of operating a fuel cell emergency power system for an aircraft, the method including receiving, by a control system, a demand signal indicative of a demand for emergency power, and in response to receiving the demand signal, controlling, by the control system initiating a supplying of hydrogen gas to a fuel cell system, initiating a supplying of air received at a ram air intake and warming the air received at the ram air intake, and providing the warmed air to the fuel cell system, and generating, by the fuel cell system, a supply of power at a power output from the supply of hydrogen gas and the supply of air, wherein generated supply of power is proportional to the demand signal.

### BRIEF DESCRIPTION OF THE DRAWINGS

In the drawings:

FIG. 1 illustrates a top down schematic view of an aircraft and power distribution system, in accordance with various aspects described herein.

FIG. 2 illustrates a schematic view of the operation of a fuel cell in accordance with various aspects described herein.

FIG. 3 illustrates a schematic view of a fuel cell emergency power system (FCEPS), in accordance with various aspects described herein.

FIG. 4 illustrates a schematic view of a hydrogen storage system of the FCEPS of FIG. 3, in accordance with various aspects described herein.

FIG. 5 illustrates a schematic view of an air delivery system of the FCEPS of FIG. 3, in accordance with various aspects described herein.

FIG. 6 illustrates a schematic view of a fuel cell system of the FCEPS of FIG. 3, in accordance with various aspects described herein.

FIG. 7 illustrates a schematic view of an electrical converter system of the FCEPS of FIG. 3, in accordance with various aspects described herein.

FIG. 8 illustrates a schematic view of a heat management system of the FCEPS of FIG. 3, in accordance with various aspects described herein.

### DETAILED DESCRIPTION

The invention can be implemented in any environment using a fuel cell system to provide supplemental power or replacement power for existing electrical power systems, for example, on a vehicle such as an aircraft. As used herein, supplemental power can include providing electricity to a set of electrical systems simultaneously with an existing power source, such as a generator or a battery system. Also as used herein, replacement power for an existing electrical power system can include providing electricity to the same or different sets of electrical systems in place of, or standing in for, a power supplying system that no longer supplies electrical power, such as in the event of a power system failure, or under emergency operations. Additionally, while an aircraft is described, embodiments of the disclosure are equally applicable for land or sea-based vehicles.

One non-limiting example of such a fuel cell system can include an environment using hydrogen as a fuel for creating consumable energy, for example, by way of conversion from chemical energy into electrical energy through a chemical reaction.

A Fuel Cell Emergency Power System (FCEPS) is a fuel cell system, as described above, that utilizes a Proton Exchange Membrane (PEM) Fuel Cell, a hydrogen storage system, such as a solid hydrogen storage system, an air delivery system, a power converter, and a heat management system, together with an overall Control system, to generate electrical power during emergency operations. Together they replicate the functions provided by the ram air turbine system (RAT) used on an aircraft, and can supplement the power provided by the RAT system, or can be used to replace the RAT system.

The hydrogen storage system includes a containment vessel and supporting infrastructure that provides hydrogen from an inert source at relatively low pressure (less than 10 bar) for consumption in the fuel cell. The hydrogen is released from the source material by a chemical reaction triggered by at least two independent control mechanisms. Hydrogen can be generated at a controlled rate matched to the Fuel Cell load demands or at a constant rate which would provide enough hydrogen for maximum Fuel Cell load demand with the excess Hydrogen diluted with air or depleted air and vented overboard.

The PEM fuel cell can be configured to provide direct current (DC) electrical power through the reaction of the hydrogen gas and oxygen. The air delivery system provides the oxidant required by the fuel cell, for example, from a ram air source which can further be conditioned for the fuel cell. Conditioning the ram air source for the fuel cell can include adjusting, regulating, or modifying the air pressure, temperature and flow rate, prior to being received by the fuel cell. The power converter system can provide electrical power generated to match or conditioned to match the aircraft emergency power requirements. Some non-limiting examples of aircraft emergency power requirements can include one or a combination of 28V DC, 115V AC, 230 V AC, 270V DC, or positive or negative 270V DC supplies. A heat management system can be configured to recover heat or excess heat from the fuel cell system and transfers the heat to the ram air to raise the air temperature, if needed. The overall control system provides control of the subsystems for both start up and normal operation together with built-in testing (BIT) and system health reporting to the aircraft system.

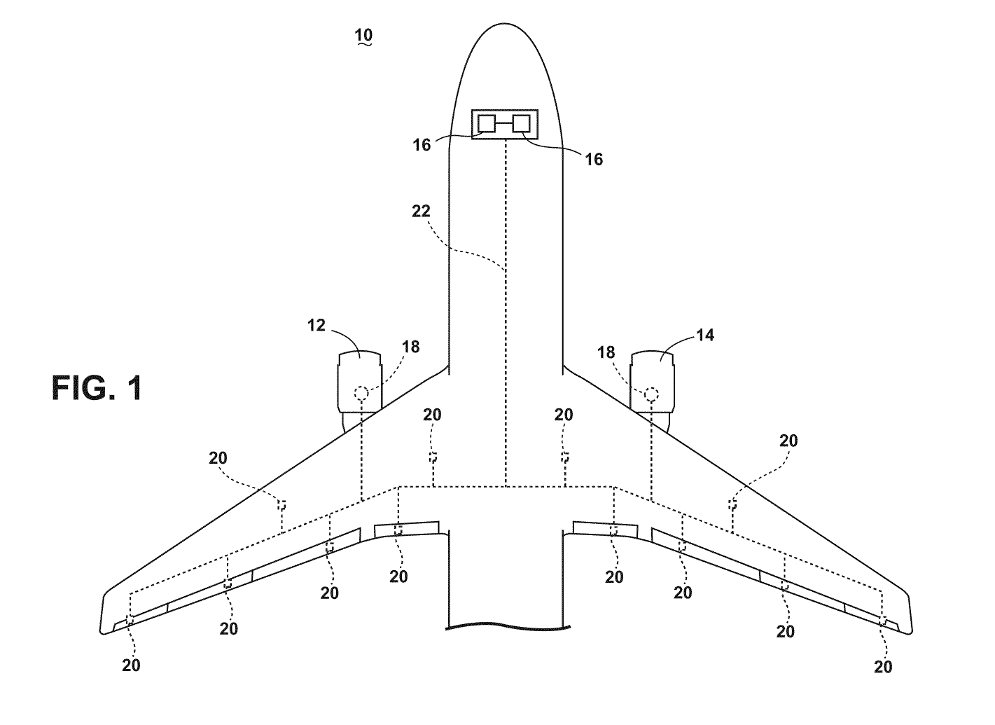

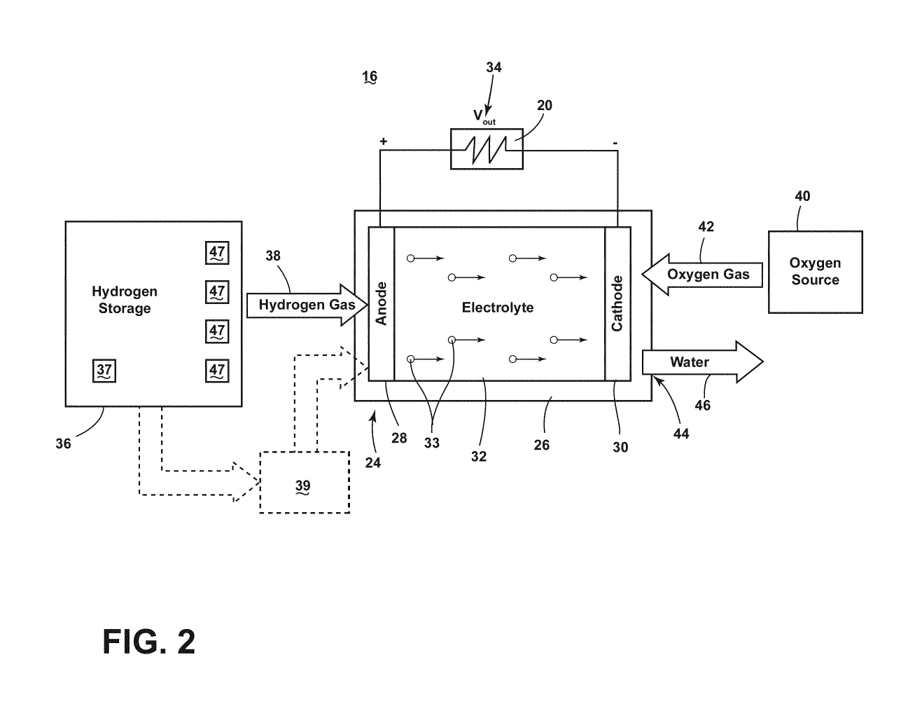

A brief explanation of an aircraft power system and fuel cell operation, according to embodiments of the disclosure, is provided with reference to FIGS. 1 and 2, for understanding.

As illustrated in FIG. 1, an aircraft 10 is shown having at least one gas turbine engine, shown as a left engine system 12 and a right engine system 14. Alternatively, the power system can have fewer or additional engine systems. The left and right engine systems 12, 14 can be substantially identical, and can further comprise at least one electric machine, such as a generator 18. The aircraft is shown further comprising a set of power-consuming components, or electrical loads 20, for instance, an actuator load, flight critical loads, and non-flight critical loads. The electrical loads 20 are electrically coupled with at least one of the generators 18 via a power distribution system, for instance, bus bars 22. In the aircraft 10, the operating left and right engine systems 12, 14 provide mechanical energy which can be extracted via a spool, to provide a driving force for the generator 18. The generator 18, in turn, provides the generated power to the bus bars 22, which delivers the power to the electrical loads 20 for load operations.

The aircraft 10 or power system can include additional power sources for providing power to the electrical loads 20, and can include emergency power sources 16, ram air turbine systems, starter/generators, batteries, super capacitors, or the like. The depiction of the aircraft 10, emergency power sources 16, engines 12, 14, generators 18, electrical loads 20, and bus bars 22 are provided merely as one non-limiting example schematic aircraft 10 configuration, and is not intended to limit embodiments of the disclosure to any particular aircraft 10 or operating environment. It will be understood that while one embodiment of the invention is shown in an aircraft environment, the invention is not so limited and has general application to electrical power systems in non-aircraft applications, such as other mobile applications and non-mobile industrial, commercial, and residential applications.

Additionally, while various components have been illustrated with relative position of the aircraft (e.g. the emergency power sources 16 near the head or cockpit of the aircraft 10), embodiments of the disclosure are not so limited, and the components are not so limited based on their schematic depictions. For example, the emergency power sources 16 can be located in an aircraft 10 wing, a tail section, or farther toward the rear of the aircraft fuselage. Additional aircraft configurations are envisioned.

FIG. 2 illustrates an example configuration of operation of an emergency power source 16, shown as a fuel cell system 24, in accordance with various aspects described herein. The fuel cell system 24 includes a fuel cell 26 including an anode 28 (positive side of the fuel cell 26) and cathode 30 (negative side of the fuel cell 26) separated by an electrolyte 32 that allows positively charged hydrogen ions 33 to move between the anode 28 and cathode 30. The fuel cell 26 can include a voltage output 34 electrically coupled with the anode 28 and cathode 30 to provide current or electrical power generated between the anode 28 and cathode 30. The voltage output 34 can, for example, power one or more electrical loads 20, illustrated by a representative single load 20.

The fuel cell system 24 additionally includes a hydrogen storage system 36 including a set of hydrogen storage units 47 in communication with the anode 28 of the fuel cell 26 such that the hydrogen storage system 36 can provide hydrogen gas 38 to the anode 28. The hydrogen storage units 47 can be configured to provide the hydrogen gas 38 independently of, or simultaneous with, other units 47, as designed base on the hydrogen gas 38 needs or demands of the fuel cell system 24. The hydrogen storage system 36 can optionally include a controller module 37 configured to control the operation of the storage system 36 or the operation of the set of hydrogen storage units 47, which will be further explained below. The fuel cell system 24 can further include an oxygen source 40 configured to provide oxygen gas 42 to the cathode 30 of the fuel cell 26, and a water outlet 44 for removing water 46 from the cathode 30 of the fuel cell 26. While an oxygen source 40 is depicted, other sources of oxygen can be included, such as ambient air.

The fuel cell system 24 can optionally include an intermediary hydrogen gas storage unit 39, illustrated in dotted outline, configured to store the hydrogen gas 38 or excess hydrogen gas 38 that has been provided by the hydrogen storage system 36 or hydrogen storage units 47. Configurations of the fuel cell system 24 can be included wherein the hydrogen gas 38 is supplied to the anode 28 only by way of the optional intermediary hydrogen gas storage unit 39. One non-limiting example of an intermediary hydrogen gas storage unit 39 can include a pressurized storage tank.

The anode 28 or cathode 30 can further include one or more catalysts that cause, encourage, or promote the hydrogen gas 38 to undergo oxidation reactions to generate the hydrogen ions 33 and electrons. The ions 33 can then traverse the electrolyte 32, while the electrons are drawn to the voltage output 34 or electrical load 20. In this sense, the fuel cell 26 can generate direct current (DC). At the cathode 30, the hydrogen ions 33, the electrons, and oxygen gas 42 form the water 46 which is removed from the fuel cell 26 by way of the water outlet 44.

The anode 28 and cathode 30 can be selected from various conductive materials having a potential difference and configured to produce the above-described chemical reactions. Particular anode 28 or cathode 30 materials are not germane to the invention. Additionally, the electrolyte 32 can be selected from various electrolytic materials configured for fuel cell 26 operations, including, but not limited to proton exchange membrane-type fuel cells (PEM fuel cells, or PEMFC) or solid oxide-type fuel cells. Additionally, while the fuel cell 26 is schematically illustrated as a single “cell” having one anode 28, one cathode 30, and one electrolyte 32, embodiments of the disclosure are envisioned wherein individual cells are “stacked,” or placed in series, to create a desired voltage output 34 configured to meet a particular operating requirement. For example, an emergency power source 16 can be required to deliver DC power at 270V DC. Additional or alternative power operating requirements are envisioned wherein, for example, multiple stacked fuel cells 26 can be configured in parallel to provide additional current. Moreover, while the illustrated embodiment describes a DC voltage fuel cell system 24, embodiments of the disclosure are equally applicable with fuel cell systems 24 configured to provide an alternating current (AC) voltage output, for example, by way of an inverter system (not shown).

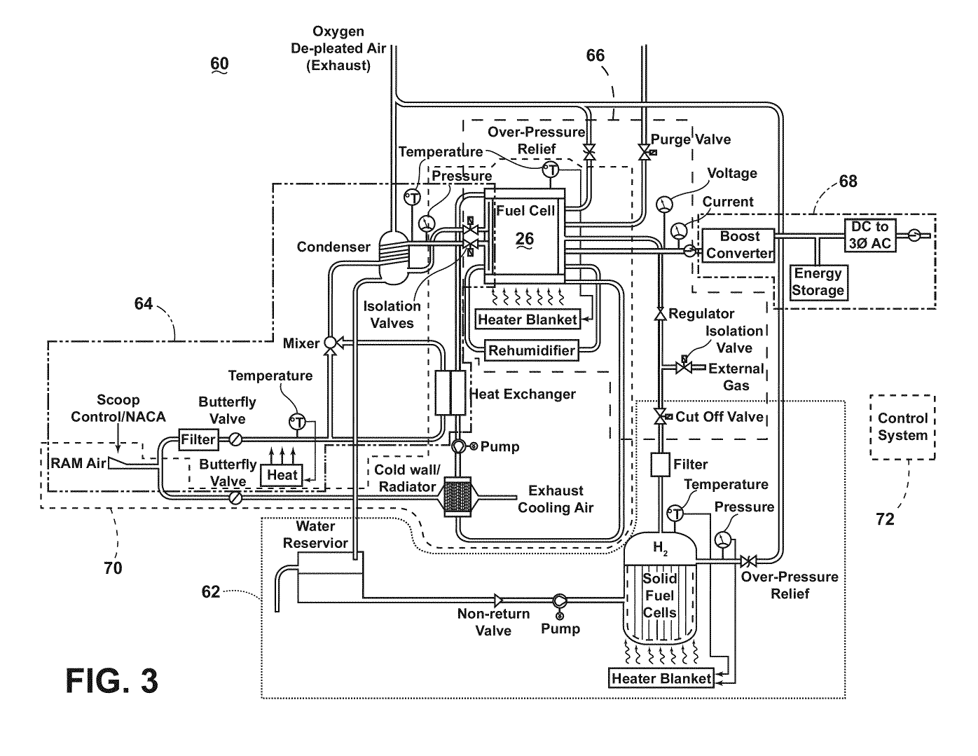

FIG. 3 illustrates a more detailed schematic of the Fuel Cell Emergency Power System (FCEPS) 60, according to embodiments of the disclosure. The FCEPS 60 can include a hydrogen storage system 62, an air delivery system 64, a fuel cell system 66 including the fuel cell 26, an electrical converter system 68, and a heat management system 70, together with an overall control system 72. A set of the aforementioned systems 62, 64, 66, 68, 70, 72 can include elements or aspects that overlap with other systems, thus embodiments of the disclosure can include redundant, duplicated, or combined elements for improved efficiency. For clarity in understanding, the systems 62, 64, 66, 68, 70, 72 will be explain individually.

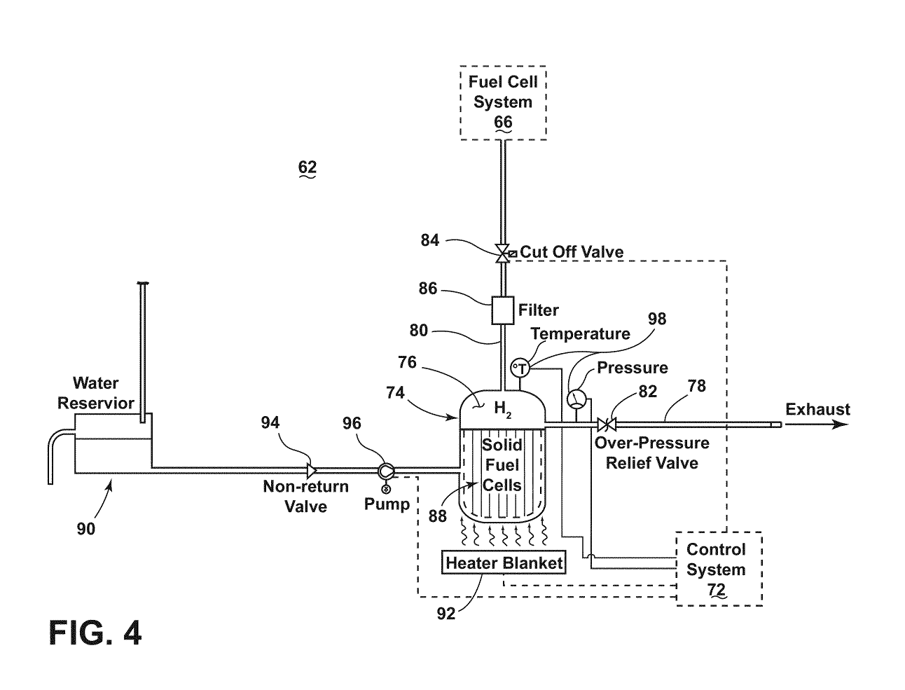

FIG. 4 illustrates one example of the hydrogen storage system 62, according to embodiments of the disclosure. The hydrogen storage system 62 can include a pressure vessel 74, configured to fluidly isolate a pressurized interior 76 of the vessel 74 having hydrogen gases from the surrounding environment. The pressure vessel 74 can further include a first output 78 fluidly coupled with the interior 76 and configured to provide selective pressure relief for the interior 76, and a second output 80 fluidly coupled with the interior 76 and configured to provide or deliver hydrogen gas from the hydrogen storage system 62 to the fuel cell system 66.

The hydrogen storage system 62 can optionally include the control system 72, which can be configured to control the operation of the FCEPS 60, which will be further explained below. While the control system 72 is described as a portion of the hydrogen storage system 62, embodiments of the FCEPS 60 can include a control system 72 located away from or apart from the hydrogen storage system 62, or decentralized from any of the systems of the FCEPS 60. The control system 72 is illustrated schematically coupled to components, but is not intended to limit configuration, location, or proximity to any particular FCEPS 60 component.

The output 80 can be selectively controlled by, or selectively supply hydrogen gas to the fuel cell system 66 by, for example, a cut-off valve 84 communicatively controllable by the control system 72. An over-pressure relief valve 82 can be coupled in-line with the first output 78 and can be configured to automatically open when pressure reaches a set point or a predetermined pressure limit.

The hydrogen storage system 62 is illustrated including additional optional components, including a filter 86 located at the second output 80 configured to filter out contaminates or impurities originating from the pressure vessel 74 from the hydrogen gas. Additional optional components can include elements configured to release or generate hydrogen gases within the pressure vessel 74. For example, while the vessel 74 is described having hydrogen gases, embodiments of the disclosure can include utilizing a hydrogen storage solid, such as a set of solid fuel cells 88 located within or external to the pressure vessel 74, and configured to release hydrogen gas in response to a chemical reaction.

Non-limiting examples of a chemical reaction can include a reaction initiated or sustained by water, supplied by an optional water reserve 90 fluidly coupled with the interior 76 of the pressure vessel 74, and heat supplied to the pressure vessel 74 by an optional heating element, such as a heater blanket 92. The supplying of water can be selectively controlled by way of, for example, a non-return valve 94 or a pump 96 communicatively coupled by the control system 72, and the supplying of heat can be selectively controlled by way of, for example, the heater blanket 92 communicatively coupled with the control system 72. Non-limiting examples of the water reservoir 90 can include water provided by the fuel cell system 66 reaction, water condensed using the cool air derived from aircraft ram air, or other aircraft air systems, or on-board water supply sources.

The heater blanket 92 can be powered by a separate power source of the aircraft, such as a battery, the electricity generated by the FCEPS 60, or operate by way of heat generated by another aircraft system. Embodiments of the hydrogen storage system 62 can further include mixing or agitation components for the set of solid fuel cells 88, and a set of sensors, such as pressure or temperature sensors 98 configured to sense or measure respective pressure and temperature values of the storage system 62. The sensors 98 can be configured to provide the sensed or measure values to the control system 72, and the control system can be configured to operate the valves 84, 94, pump 96, or heater blanket 92 in response to the sensor 98 values.

The hydrogen storage system is configured to generate, supply, or provide hydrogen gas, for example, at low pressure, at a flow rate configured to supply the fuel cell system 66 at maximum output. In this sense, embodiments of the disclosure can include initiating or sustaining a controlled chemical reaction to generate the hydrogen gas at the aforementioned flow rate. Hydrogen gases produced above the demand of the fuel cell system 66 can be optionally stored within the system, stored in an intermediary storage system (not shown), or vented to the environment, for example, by the first output 78 and over-pressure relief valve 82.

The hydrogen storage system 62 can include a single-use or a single shot device capable of or configured to supply predetermined amounts of hydrogen gases or a predetermined flow rate of hydrogen gases to meet the power and deployment requirements of the emergency power system. For example, the control system 72 can be configured to stagger the initiation of the chemical reaction of the hydrogen storage system 62 to maintain the pressure of hydrogen gases or the vessel 74 to between 6 bar and 15 bar. In another example embodiment, the hydrogen storage system 62 can include a plug-in cartridge having the source of hydrogen gas, such as the hydrogen storage solid. In this example, the source can be used once until diminished, empty, or chemically reacted in whole, or partly used. Once the source has been fully or partly used, the source can be removed and replaced with a new source. Additionally, the control system 72 can be configured such that the pressure and temperature sensors 98 can be used to periodically measure operating conditions of the hydrogen storage system 62 to ensure that there has been no leakage of hydrogen gases from the storage material.

As explained above, the hydrogen storage system 62 can include a set of solid fuel cells 88 in the interior 76 of the vessel 74, wherein the solid fuel cell 88 can release hydrogen when commanded by the control system 72. The release of hydrogen from the set of fuel cells or a subset of the cells 88 will continue until the reaction is complete. Multiple solid fuel cells 88 can be used to minimize the containment required for the hydrogen produced by the reaction, or maximize the amount of hydrogen storage per weight or per volume. A multiple solid fuel cell system 62 can require a smaller hydrogen storage pressure vessel 74 as the hydrogen can be released from cells 88 individually. In this embodiment, the size of the set or subset of the solid fuel cells 88, or the controlled release of the hydrogen gases, can be configured, designed, or matched with a normal or a predetermined operating pressure for the hydrogen storage system 62 or vessel 74 pressure.

In embodiments of the solid fuel cells 88, the hydrogen is released from a cell 88 when the chemical reaction is initiated, and the chemical reaction is allowed to complete. Embodiments of the disclosure can include additional control or control mechanisms, such as by the control system 72, such it is possible to limit the amount of hydrogen released by the reaction by restricting the supply of a reactant, such as the water, or by limiting or restricting the supply of heat. Further embodiments of the disclosure can include releasing hydrogen from a set of solid fuel cells 88 via chemical reaction, wherein the chemical reaction occurs without additional heat (e.g. wherein the optional heater blanket 92 can be unnecessary).

One example of the set of solid fuel cells 88 can include a hydrogen storage solid such as a metal hydrides, Lithium Hydride, or Lithium Borohydride. Additionally, the chemical reaction described herein can include chemical acceleration by way of a catalyst or by destabilizing the hydrogen storage solid material.

The control system 72 of the FCEPS 60 can be configured to control the operation of the hydrogen storage system 62, as well as the operation of additional systems, as explained herein. The control system 72 can control these operations based on, for example, receiving a demand signal indicative of a demand for hydrogen gases or a demand for emergency or supplements electrical power. The demand signal can originate from an aircraft system indicating the emergency or supplemental amount of electrical power is requested to be generated by the FCEPS 60, such as during emergency operations. In such an example, the control system 72, in response to receiving the demand signal, can control the initiation of the aforementioned chemical reactions in the hydrogen storage system 62, as explained herein.

Additionally, embodiments of the demand signal can include a signal that provides a binary indication of a demand for hydrogen gases or electricity, and the control system 72 can operate a portion of a computer program having an executable instruction set for controlling the operations of the FCEPS 60 according to a predetermined profile, predetermined design, or operational characteristic, as described above. The fuel cell 26 can then generate electricity from the liberated hydrogen gases.

The computer program having an executable instruction set can be included as part of, or accessible by, the control system 72 in a machine-readable media for carrying or having machine-executable instructions or data structures stored thereon. Such machine-readable media can be any available media, which can be accessed by a general purpose or special purpose computer or other machine with a processor. Generally, such a computer program can include routines, programs, objects, components, data structures, and the like, that have the technical effect of performing particular tasks or implement particular abstract data types. Machine-executable instructions, associated data structures, and programs represent examples of program code for executing the exchange of information as disclosed herein.

Alternatively, embodiments of the demand signal are envisioned wherein the demand signal can further include a quantitative element of the demand for hydrogen gases or electricity, for instance, a high demand, a medium demand, or a low demand. The quantitative element of the demand signal can be further related to, for example, different operating profiles for supplemental power (e.g. a small amount of supplemental power versus a large amount of supplemental power). The quantitative element of the demand for hydrogen gases can have the technical effect of operating different computer programs, or modifying the execution of the computer programs to adjust for the particular demand.

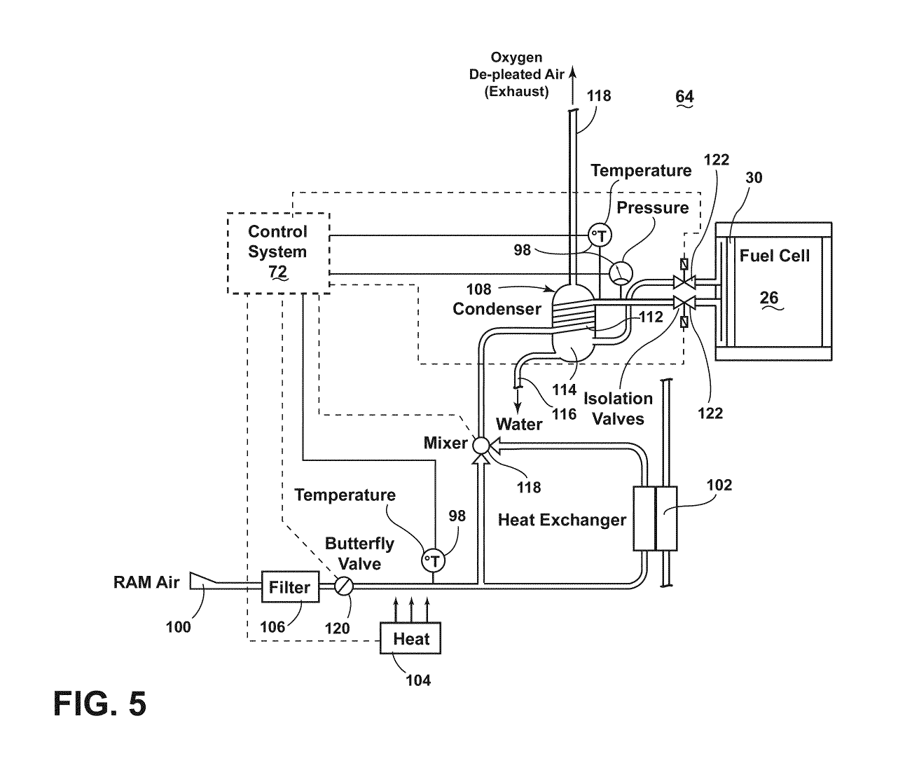

FIG. 5 illustrates one example embodiment of the air delivery system 64 of the FCEPS 60. As shown, the air delivery system can include an air intake 100, for example, configured to receive ram air while the aircraft is flying, a heating source, such as a heat exchanger 102 or a heater 104, and a fluid coupling 112 configured to deliver, provide, or supply air received at the air intake 100 to the cathode 30 of the fuel cell 26. The air delivery system 64 can include optional components such as an intake filter 106 to filter contaminants and the like from air received by the air intake 100 or a condenser 108 configured to condense water from warm oxygen depleted air exiting the cathode 30 of the fuel cell 26.

The air delivery system 64 can be configured to provide the fuel cell 26 with air (referred to as fuel cell oxidant) at a predetermined temperature or within a predetermined temperature range to ensure fuel cell 26 operation. Air received or drawn in at the air intake 100 can originate from the outside of the aircraft during flight operations, which can include air at temperatures as low as −80 degrees Celsius. In one example configuration, the fuel cell 26 can require air having a temperature above 4 degrees Celsius.

The air delivery system 64 can heat air received at the air intake 100 by way of the heat exchanger 102, the heater 104, or a combination thereof, to raise the temperature of intake air to at least a predetermined temperature for fuel cell 26 operations, such as 4 degrees Celsius. The heater 104 can be communicatively coupled with and controlled by the control system 72, as needed. Additionally, the control system 72 can be communicatively coupled with a temperature sensor 98 configured to sense or measure the temperature of the air received into the air delivery system 64, for example, at or near the air intake 100, and can operate the heater 104 in response to the sensed or measured temperature. As described above, the heater 104 can be powered by a separate power source of the aircraft, such as a battery, the electricity generated by the FCEPS 60, or operate by way of heat generated by another aircraft system. Additionally, the heat exchanger 102 can include heat provided by another heat-generating source or supply. The heat exchanger 102 heat source can include any heat-generating source on the aircraft, or another heat-generating source of the FCEPS 60.

Air received at the air intake 100 can be filtered by the filter 106, and pass by at least one of the heater 104 or heat exchanger 102 to warm the air to the predetermined temperature or the predetermined temperature range. As shown, an optional mixer valve 110 can be configured to mix air received by the air intake 100, air warmed by the heater 104, or air warmed by the heat exchanger 102 to ensure the air entering the fuel cell 26 is at or within the predetermined temperature range. In this example, the mixer valve 110 can be controllably operated by the control system 72, for example, in response to a temperature sensed by the temperature sensor near the air intake 100.

The warmed air (e.g. at 4 degrees Celsius) is delivered downstream from the mixer valve 110 to the condenser 108, wherein the air stream can be configured, via piping 112, to encircle or a condenser vessel 114. The warmed air is still cool enough to act as a cooling source for the condenser vessel 114, and then the warmed air is delivered to the cathode 30 of the fuel cell 26. After fuel cell 26 operations, hot, moist oxygen depleted air (air heated by fuel cell 26 operations and having water 46, as described above) is delivered from the cathode 30 to the condenser vessel 114, where water is condensed from the hot, moist oxygen depleted air by the condenser piping 112. The condenser 108 can be configured to collect the condensed water at a water output 116, which can, for example, be configured to supply water to the water reservoir 90. Stated another way, the condenser 108 operates using cooler air to condense or recover the water vapor output by the fuel cell 26, and the recovered water can contribute to water used by the chemical reaction to release the hydrogen gases from the hydrogen storage system 62. Additional hot dry oxygen depleted air can additionally be vented from the condenser vessel 114 by a vent output 118. As this air is oxygen depleted it can be used to dilute any hydrogen exhaust.

The air delivery system 64 can optionally include additional temperature and pressure sensors 98, for example, located downstream from the condenser piping 112, to ensure predetermined air pressure and air temperature is reaching the cathode 30 of the fuel cell 26. The sensors 98 can be communicatively coupled with the control system 72, which can further control FCEPS 60 operations in response to the sensor 98 signals. Additionally, a set of optional valves can be communicatively and controllably coupled with the control system 72 to control delivery of air in the air delivery system 64. Optional valves can include a butterfly valve 120 located downstream from the air intake 100 or upstream from the heating elements 102, 104, and isolation valves 122 positioned upstream and downstream from the fuel cell 26.

During starting up of the FCEPS 60 operations, a lower volume of fuel oxidant or intake air is required, and the starting up intake air will be heated by, for example, electrical power supplied to the heater 104 from the on-board batteries used in the aircraft electrical system. During normal operations of the FCEPS 60, the fuel cell 26 can provide the electrical power needed to operate the heater 104, these will be recharged by the excess power of the fuel cell emergency power system when the system is in normal operation mode. Alternatively, during normal operation mode the heat dissipated by the fuel cell 26 or the hydrogen storage system 62 or chemical reaction can be used to heat the incoming air by way of the heat exchanger 102, and the heater 104 can supplement the heating of the intake air, as needed. Embodiments of the disclosure can include configurations wherein air can be delivered at the peak rate required to achieve maximum output power of the fuel cell 26 or can be controlled, for example, by the control system 72, to meet the demanded power of the full cell 26.

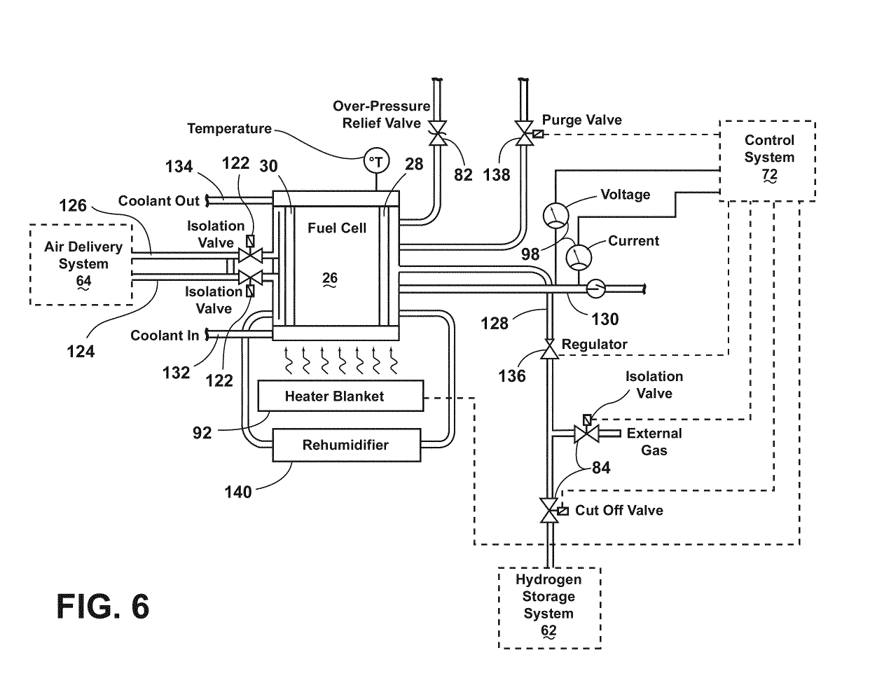

FIG. 6 illustrates a more detailed schematic view of the fuel cell system of FIG. 2, incorporating aspects of the FCEPS 60. As shown, the fuel cell system 66 includes a fuel cell 26 having an anode 28 and cathode 30. The cathode 30 is further coupled with an air input 124 and an oxygen depleted air output 126, coupling the fuel cell system 66 with the air delivery system 64. The anode 28 can further include a hydrogen gas supply input 128, coupling the fuel cell system 66 with the hydrogen storage system 62. The fuel cell 26 further includes a power output 130 configured to deliver power generated by fuel cell 26 operations to the electrical converter system 68. The power output 130 can optionally include sensors 98, such as a voltage sensor or current sensor, which can further provide sensed or measured voltage or current signals to the control system 72.

As explained herein, the fuel cell 26, such as a PEM fuel cell, is configured to operate by splitting the hydrogen gas into protons and electrons using a catalyst (non-limiting examples of which can include platinum, which allows the splitting to take place at a low enough temperature) at the anode 28. The electrons provide the electric current through the electrical path, and out of the fuel cell via the power output 130, and the protons pass through the membrane, across the hydrated electrolyte 32 and then combine with the electrons and oxygen to form water at the cathode 30. The fuel cell 26 operation can also provide heat as a byproduct to generating electricity.

The chemical reaction for a PEM fuel cell 26 can include, but is not limited to the reaction shown below:

Anode: H₂->H⁺+2e⁻

Cathode: ½O₂+2H⁺+2e⁻->H₂O

Overall: ½O₂+2H⁺+2e⁻->H₂O

The temperature of the fuel cell 26 or of the chemical reaction operation can be between 4 degrees Celsius and 65 degrees Celsius. These limits can be the result of the water molecules in the membrane and water produced by the reaction. At temperatures below 4 degrees Celsius, there is a risk of the water freezing, while at temperatures above 65 degrees Celsius the efficiency of the hydrated electrolyte 32 drops when the water molecules start to vibrate excessively. The excessive vibrations can impede the proton flow. At temperatures above 100 degrees Celsius, the electrolyte 32 dries out due to evaporation of the water molecules. Alternative fuel cell systems 66 included by this disclosure can be configured to operate at temperatures above 65 degrees Celsius by, for example, increasing the pressures within the fuel cell 26.

The fuel cell system 66 of the FCEPS 60 can be configured such that the system 66 is not designed for longevity. For instance, in one non-limiting example, the operational life can be configured to include a minimum of 200 hours. A fuel cell system 66 not designed for longevity can allows higher levels of hydrogen impurities and non-optimized hydrogen usage and leads to a significantly simpler fuel cell system design.

Additional optional components are shown included in the fuel cell system 66, including a cooling system having a coolant inlet 132 and a coolant outlet 134. The coolant inlet 132 and outlet 134 can include a cooling circuit included with the fuel cell 26 and configured to remove heat generated by the fuel cell 26 during electricity-generating operations. The complete cooling circuit or cooling system is not shown for ease of understanding. The coolant inlet 132 and outlet 134 can be further coupled to additional systems to provide heat or heating elements, such as the heat exchanger 102 of the air delivery system 64.

The fuel cell system 66 can additionally include optional cut-off valves 84, or regulator valves 136, communicatively coupled with and controllable by the control system 72, and configured to regulate supply of the hydrogen gases to the anode 28 of the fuel cell 26. The fuel cell 26 can also include an over-pressure relief valves 82 and can be configured to automatically open when pressure reaches a set point or a predetermined pressure limit. The fuel cell 26 can additionally include a purge valve 138 which is communicatively coupled with and controllable by the control system 72, and configured to purge hydrogen gases from the fuel cell 26, if needed. In another embodiment of the disclosure, the fuel cell system 66 can include a rehumidifier 140 to provide additional hydration to the cathode 30, to mitigate effects of potentially dry air received at the cathode 30 by the air delivery system 64. In yet another embodiment of the disclosure, the fuel cell system 66 can include a heater or heater blanket 92 used to prepare the system for deployment in cold conditions. The heater blanket 92 can, for example, provide a very low heat output throughout the flight and can be powered by a separate power source of the aircraft, such as a battery, or operate by way of heat generated by another aircraft system.

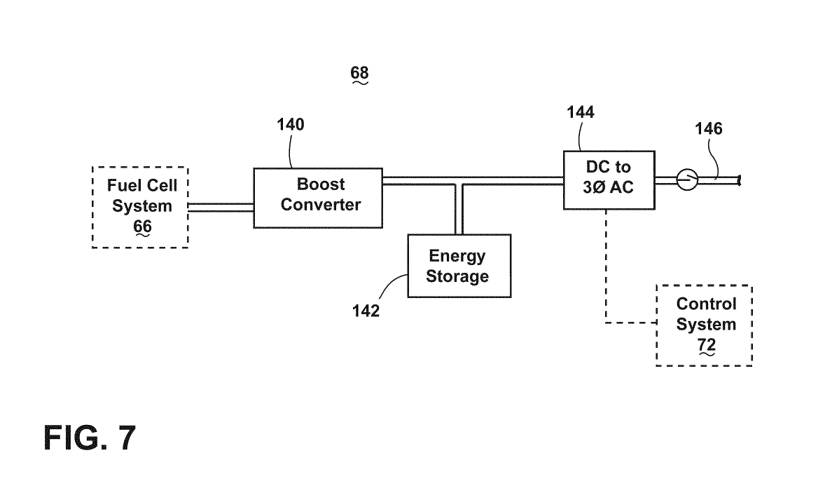

FIG. 7 illustrates the electrical converter system 68 configured to convert the electrical power output 130 of the fuel cell system 66 to the desired electrical output, for example, the power outputs utilized by the aircraft or emergency power systems. The electrical converter system 68 can include a boost converter 140 configured to receive the electrical power output 130 of the fuel cell system 66, and provide an output having a voltage greater than the input voltage, to, for example, a DC power bus for powering electrical systems of the aircraft.

Alternative electrical converter systems 68, as shown, can include supplying DC power from the boost converter 140 to an energy storage unit 142 or set of storage units 142, or to a direct current to alternating current (DC to AC) converter 144 configured to convert the DC output to AC output and supply power at an AC power output 146 for the aircraft or other electrical systems. The DC to AC converter 144 can be configured to convert and supply power at, for example, 115 V AC, 230 V AC, or three-phase AC power at a predetermined voltage. As shown, the DC to AC converter 144 can be communicatively couple with and controlled by the control system 72 to generate power at the AC power output 146, as needed.

The energy storage unit 142 can be configured to cater to or account for the latency in the time of the fuel cell system 66 to the change the amount of electricity generated in response to changing load demands. The energy storage unit 142 can include a rechargeable battery a super capacitor, or a set or combination thereof, depending on the overall step response and the desired dynamics of the power system.

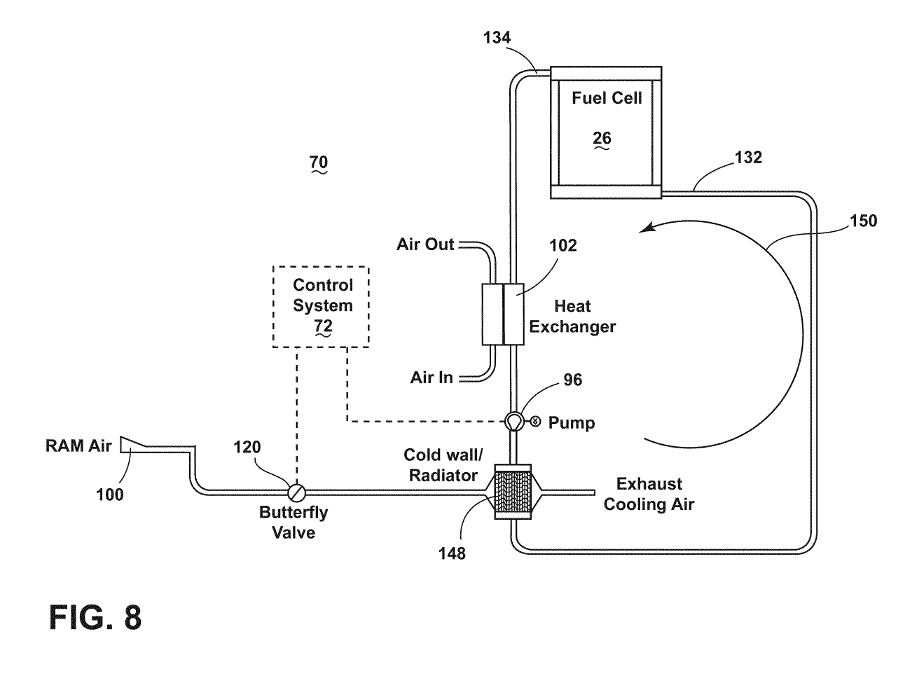

FIG. 8 illustrates the heat management system 70 of the FCEPS 60. The heat management system 70 can include the cooling system or coolant loop 150 (illustrated via loop arrow), including the coolant input 132 and coolant outlet 134 of the fuel cell 26. The cooling system or coolant loop 150 can also include the heat exchanger 102, a cold wall or radiator 148, and a pump 96 configured to pump coolant through the loop 150. The radiator 148 can be thermally coupled with an fluid path configured to allow air, such as air received at the air intake 100, such that the air interacts with the radiator 148 to cool coolant traversing the radiator 148 and coolant loop 150. The heat management system 70 can include additional components, such as a butterfly valve 120, which can be communicatively coupled with and controllable by the control system 72 to regulate the amount of air provided to the radiator 148. Additionally, the pump can be communicatively coupled with, and controlled by, the control system 72.

As shown, coolant loop 150 can be defined by a coolant path wherein coolant can be pumped, by the pump 96, from the radiator 148 to the fuel cell 26 where the coolant absorbs and removes heat generated by the fuel cell 26. Coolant leaving the fuel cell 26 can then be pumped to the heat exchanger 102 where the coolant can warm air for the air delivery system 64, and back to the radiator 148 where the coolant is cooled for further use. While not shown, the coolant loop 150 can be extended or routed to cool additional systems, including, but not limited to, the electrical converter system 68 or the hydrogen storage system 62. Alternatively, secondary coolant loops can be included.

The embodiments disclosed herein provide a method and apparatus for generating electricity from a fuel cell system for an aircraft. The technical effect is that the above described embodiments enable the controlled liberation of the hydrogen gases and generation of electricity from the hydrogen gases via a fuel cell, in accordance with design considerations and operational characteristics described herein. One advantage that can be realized in the above embodiments is that the above-described embodiments have superior hydrogen storage capabilities without the safety concerns of storing gaseous hydrogen at high pressures. The solid hydrogen storage of the hydrogen storage system minimalizes the potential energy of the hydrogen storage system, eliminates the danger hydrogen gas leaks at high pressure storage, and ensures the longevity of the hydrogen being stored. Longevity of the hydrogen being stored leads to fewer maintenance operations to maintain the overall system.

Additionally, because the above-described embodiments of the disclosure operate at low pressures, no high pressure hydrogen infrastructure is required, reducing manufacturing and certification costs. Thus, the capabilities of hydrogen gases on demand provide for safer handling, lower pressure systems, and multiple methods of controlling the chemical reactions, ensuring the low pressure environment.

Another advantage of the above-described embodiments is that the individualized hydrogen storage units, along with selective control of the units, results in a hydrogen storage system that can be scaled to for the amount of hydrogen gases supplied, providing efficiencies of size and weight to suit the need. Additionally, the hydrogen storage solids described herein have a high hydrogen storage capacity, providing a high weight of stored hydrogen, and a lower overall system weight. In yet another advantage, non-reversible or non-rechargeable hydrogen storage solids can be individually replaced, as described herein. When designing aircraft components, important factors to address are size, weight, and reliability. The above described hydrogen storage system results in a lower weight, smaller sized, increased performance, and increased reliability system. The stable storage of hydrogen in a solid state reduces maintenance needs and will lead to a lower product costs and lower operating costs.

Yet another advantage of the above-described embodiments is that the fuel cell system design alleviates the need for expensive and time consuming maintenance required by a conventional RAT emergency power system. Additionally, the system can be periodically tested using built in test. Moreover, the fuel cell system can operate at higher altitude than a conventional RAT system which, for example, during emergency operations, will increase allowable glide time if one or more of the aircraft engines have failed. In addition to operating at a higher altitude than a RAT system, the system can operate at lower altitude and lower speed than conventional RAT. Capabilities to operate at a lower altitude and at lower speeds allow increase the time before the aircraft has to complete landing, including increasing opportunities to abort landings, or go around and re-try a landing, if thrust is still available.

Yet another advantage of the above-described embodiments is that the system reduces drag on an aircraft during an emergency when compared to the deployment of a conventional RAT system, which requires blades to be exposed to the airstream to generate electricity. Reduced drag further increases glide time and aircraft stability.

Yet another advantage of the above-described embodiments is that the system can be turned off or disabled if the emergency or emergency condition subsides. In this scenario, so that the aircraft can potentially continue the flight to its original conclusion. Contrast this result with a conventional RAT system, which cannot be retracted once deployed, and thus, the aircraft cannot continue to original destination due to the increased drag and reduced altitude.

Yet another advantage of the above-described embodiments is that with very few moving parts and the ability to run a Built in Test (BIT) to fully test the system prior to dispatch or enablement, the reliability and maintainability of the above-described system will be higher than a conventional RAT system. Improved reliability and maintainability will reduce the amount of time the aircraft is taken out of service for periodic system maintenance. Additionally, full fuel cell system performance can be maintained throughout the deployment time at various altitudes and air speeds until the stored hydrogen fuel supply is exhausted, which further improves reliability and maintainability.

Yet another advantage of the above-described embodiments is that the modular nature of the fuel cell system and hydrogen storage system enables the FCEPS to be distributed around the airframe. Additionally, the system can be used as an addition power source for special missions which usually require extra generators to be fitted, reducing overall weight for the aircraft. Moreover, compared to other fuel cell emergency power systems, the plug-in cartridge system or solid fuel cells of the hydrogen storage system enables easy replacement of the fuel source if used or partly used. Additionally, the fuel cell system can be stopped and restarted if necessary leading, to improved variability in operating conditions. Reduced weight and size correlate to competitive advantages during flight.

To the extent not already described, the different features and structures of the various embodiments can be used in combination with others as desired. That one feature cannot be illustrated in all of the embodiments is not meant to be construed that it cannot be, but is done for brevity of description. For example, oxygen depleted exhaust air or vented air from the FCEPS can be used to dilute the excess hydrogen generated by the hydrogen storage system, or to dilute hydrogen gases purged from the fuel cell system prior to purging the hydrogen gases from the aircraft.

Thus, the various features of the different embodiments can be mixed and matched as desired to form new embodiments, whether or not the new embodiments are expressly described. Moreover, while “a set of” various elements have been described, it will be understood that “a set” can include any number of the respective elements, including only one element. All combinations or permutations of features described herein are covered by this disclosure.

This written description uses examples to disclose the invention, including the best mode, and also to enable any person skilled in the art to practice the invention, including making and using any devices or systems and performing any incorporated methods. The patentable scope of the invention is defined by the claims, and can include other examples that occur to those skilled in the art. Such other examples are intended to be within the scope of the claims if they have structural elements that do not differ from the literal language of the claims, or if they include equivalent structural elements with insubstantial differences from the literal languages of the claims.

1. An emergency power system on an aircraft comprising:
a hydrogen storage system configured to supply hydrogen gas;
a ram air intake;
an air delivery system configured to supply air from the ram air intake at a predetermined temperature; and
a fuel cell system coupled with the hydrogen storage system and the air delivery system and configured to generate power at a power output from a chemical reaction involving the hydrogen gas and the air at the predetermined temperature.

2. The emergency power system of claim 1, further comprising a control system configured to control the hydrogen storage system and the air delivery system in response to receiving a demand for emergency power, such that the fuel cell system generates power at the power output in proportion to the demand for emergency power.

3. The emergency power system of either of claim 1 or 2, wherein the hydrogen storage system includes a hydrogen storage solid.

4. The emergency power system of claim 3, wherein the hydrogen storage solid is configured to liberate hydrogen gas from the hydrogen storage solid by way of a chemical reaction.

5. The emergency power system of claim 4, wherein the hydrogen storage solid is configured to liberate hydrogen gas by way of a chemical reaction initiated by water.

6. The emergency power system of claim 5, wherein the fuel cell system produces water as a byproduct of generating power, and the water is fluidly coupled with the hydrogen storage solid to initiate the chemical reaction.

7. The emergency power system of any preceding claim, wherein the air delivery system includes a heat exchanger configured to heat air received at the ram air intake to the predetermined temperature.

8. The emergency power system of claim 7, wherein the fuel cell system produces heat as a byproduct of generating power, and the heat is thermally coupled with the heat exchanger.

9. The emergency power system of any preceding claim, further comprising a heat management system having a coolant loop thermally coupled with the fuel cell system, and a radiator.

10. The emergency power system of claim 9, wherein the radiator is fluidly coupled with air delivery system such that air received at the ram air intake removes heat from the radiator to cool the coolant loop.

11. The emergency power system of any preceding claim, further comprising an electrical converter system electrically coupled with the power output and configured to convert power received at the power output to a predetermined aircraft power characteristic.

12. The emergency power system of claim 11, wherein the electrical converter system includes an energy storage unit.

13. An aircraft comprising:
a hydrogen storage system configured to supply hydrogen gas;
an air delivery system having a ram air intake exposed to an airstream external to the aircraft and configured to supply air at a predetermined temperature; and
a fuel cell emergency power system coupled with the hydrogen storage system and the air delivery system and configured to generate power at a power output from a chemical reaction involving the hydrogen gas and the air at the predetermined temperature.

14. The aircraft of claim 13, further comprising a control system configured to control the hydrogen storage system and the air delivery system in response to receiving a demand for emergency power, such that the fuel cell emergency power system generates power at the power output in proportion to the demand for emergency power.

15. The aircraft of either of claim 13 or 14, wherein the hydrogen storage system includes a hydrogen storage solid.

16. The aircraft of any of claims 13 to 15, wherein the air delivery system includes a heat exchanger configured to heat air received at the ram air intake to the predetermined temperature.

17. The aircraft of claim 16, wherein the fuel cell system produces heat as a byproduct of generating power, and the heat is thermally coupled with the heat exchanger.

18. A method of operating a fuel cell emergency power system for an aircraft, the method comprising:
receiving, by a control system, a demand signal indicative of a demand for emergency power; and
in response to receiving the demand signal, controlling, by the control system:
initiating a supplying of hydrogen gas to a fuel cell system;
initiating a supplying of air received at a ram air intake and warming the air received at the ram air intake, and providing the warmed air to the fuel cell system; and
generating, by the fuel cell system, a supply of power at a power output from the supply of hydrogen gas and the supply of air, wherein generated supply of power is proportional to the demand signal.

19. The method of claim 18, wherein the initiating the supplying of hydrogen gas further includes staggering the initiating of a chemical reaction in a pressurized vessel to maintain the pressure of the hydrogen gas between 6 bar and 15 bar.

20. The method of either of claim 18 or 19, further comprising ceasing the supplying of hydrogen gas and the supplying of air in response to a ceasing of receiving the demand signal.
